(19) United States
(12) Patent Application Publication
(10) Pub. No.: US 2025/0299882 A1
(43) Pub. Date: Sep. 25, 2025

(54) METHOD AND APPARATUS FOR AN ULTRA-HIGH SURFACE CHARGE ACCUMULATOR

(71) Applicant: Anthony Zeberoff, Castlegar (CA)

(72) Inventor: Anthony Zeberoff, Castlegar (CA)

(21) Appl. No.: 18/611,914

(22) Filed: Mar. 21, 2024

(51) Int. Cl. H01G 4/12; H01G 4/008

(52) U.S. Cl. CPC H01G 4/1245; H01G 4/008

(57) ABSTRACT

This invention relates to a method and device for an ultra-high surface charge accumulator. Charge densities in the order of 1-10⁵ Coulomb/m² and above are possible. The combination of high voltage, a conductive layer, a nanostructured layer, and a dielectric layer generates electric fields capable of inducing substantial surface charge, thereby acting as a charge accumulator or surface capacitor. Such a device can be combined with methods of accelerated motion to generate extremely high energy densities that enable the quantum vacuum plasma state (spacetime) to be engineered.

### REFERENCES

Frontiers of Propulsion Science, Marc Millis and Eric Davis
The Quantum Vacuum, Peter W. Milonni
Salvatore Pais, U.S. Pat No 2017/0025935 A1
John Quincy St. Clair, U.S. Pat No 2003/0209635A1

### BACKGROUND OF THE INVENTION

Recent publications by Salvatore Pais reveal new breakthrough technological possibilities to engineer the quantum vacuum plasma (QVP) when utilizing ultra-high charge densities in combination with accelerated motion, such as propellent-less propulsion, room temperature superconductors, and nuclear fusion, to name a few.

Pais observed that through rapid acceleration of charge, extremely large energy density fluxes are possible, and he shows this mathematically from the expression:

$$S = \frac{{f}_{G} {σ}^{2}}{{ϵ}_{o}} ω R \cdot {e}^{( Δ f Δ t )} \qquad equation ( 1 )$$

where f_{G} is the shape factor, σ is the surface charge density, εₒ is permittivity of free space, ω is the system angular frequency and R is the effective system radius or net vibrational/rotational displacement, and e^{(ΔfΔt)} is a harmonic resonant amplification/exponential term based on the frequency band and time period when the system enters resonance (Q factor band). This formula originates itself from the Poynting product, which can be derived from

$$S = \frac{1}{{μ}_{o}} E \times B ,$$

where E and D are the electric and magnetic field respectively. To illustrate the significance of this expression, let us say that when a 1 meter diameter disc is subjected to 30 000 RPM angular spin frequency and 50,000 Coulombs/m² surface charge, the energy density from this equation is on the order of 10²³ W/m². This is a rather noteworthy observation because it lands at the energy densities associated with gamma rays as can be seen in FIG. 1. Thus, at this rotational speed and surface charge, the device can directly interact with virtual photons in the QVP, and very little is known in public scientific literature what goes on here in a lab setting. Furthermore, this is above the energy density threshold required for thermonuclear fusion of deuterium. A device capable of directly interacting with the QVP opens the doors to scientific and technological discoveries. It is further encouraging to recognize that observable and measured phenomena like the Casimir effect and Lamb shift strongly suggest that the vacuum electromagnetic field, or the QVP, and its zero-point energy are real physical entities and not mere artifices of the quantum formalism.

The central problem in achieving power flows that are commensurate with FIG. 1, however, is how to achieve such high electrical charge densities. Rotational frequencies of 30 000 RPM and higher are readily achievable, so this is not a current limitation. This work aims to illustrate one pathway on how to achieve ultra-high surface charge densities as a prerequisite to Engineer the QVP.

### SUMMARY OF THE INVENTION

This invention, which is the subject of this present application, consists of an ultra-high surface charge accumulator and a method to generate such high surface charge densities. The ultra-high surface charge accumulator includes a high voltage power supply, an electrically conductive substrate, a nanostructured layer, and a dielectric layer. The high voltage power supply is either directly or capacitively coupled to the conductive layer. When the nanostructured layer sees the applied potential, the electric field is greatly amplified in accordance with the size of the nanostructures. The electric field is then used to polarize a dielectric layer that is in direct contact with the nanostructured layer. This dielectric layer is of a thickness in proportion to the radius of the nanostructures.

It is a feature of the present invention to provide a method and apparatus for producing ultra-high surface charge densities that enables direct engineering of the vacuum plasma state or QVP. The present invention may also be considered as one of the enabling components to interact with spacetime/vacuum-plasma-state by means discussed in patent application US 2017/0025935 A1.

### BRIEF DESCRIPTION OF DRAWINGS

FIG. 1 is a energy scale depicting various high energy phenomena

FIG. 2 is a cross section of the ultra-high surface charge accumulator

FIG. 3 is a cross section of an electric field modelling simulation of a hole in a substrate.

FIG. 4 is a cross section of a polarization modelling simulation of a hole with a dielectric layer.

FIG. 5 is a dimensional analysis for equation 4.

### DETAILED DESCRIPTION OF THE INVENTION

The preferred embodiments of the present invention are illustrated by way of examples and in the corresponding figures. The ultra-high surface charge accumulator includes an electrically conductive substrate 100, a nanostructured layer 101, a dielectric layer 102, and a high voltage power supply 103. The conductive layer 100 can be made of any electrically conductive material such as aluminum, copper, titanium, tungsten, bismuth, an alloy, or of anything similarly suitable.

The nanostructured layer 101 is comprised of ordered shapes such as holes, rods, cones, pyramids or combinations thereof. The dielectric layer is applied on top of the nanostructured layer and of a thickness in proportion to the size of the repeating nanostructure unit. The power supply is a high voltage electrostatic generator such as a Cockcroft Walton generator, a high voltage high frequency generator such as a Tesla coil-like circuit, or a combination of static plus dynamic high voltage sources.

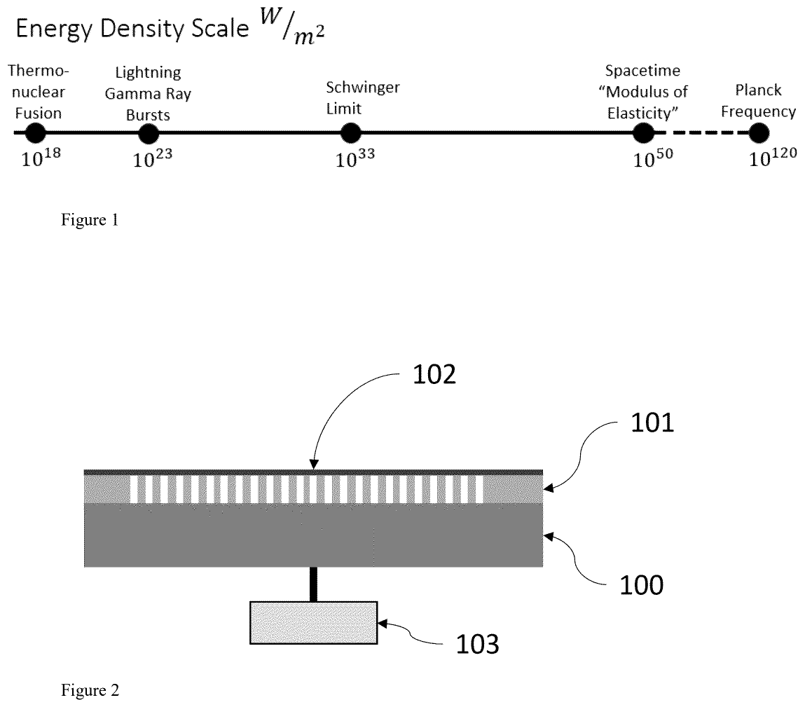

To understand how ultra-high surface densities are possible an example is put forth. For instance, computing the surface charge density for a 1 m diameter metal sphere charged to 100 kV yields 2.8×10⁻⁷ Coulombs/m², which can be found in

$$σ = {ε}_{o} {ε}_{r} E \qquad equation ( 2 )$$

where σ is the surface charge density, εₒ is linear capacitance of free space and is on the order of 10⁻¹², εᵣ is the linear capacitance of air surrounding the metal sphere equal to 1, and E is the electric field equal to the voltage divided by 2πr of the sphere. The 1 m diameter charged metal sphere immersed in air is 11 orders of magnitude away from the surface charge density prescribed above (50,000 Coulombs/m²) required to produce matter-antimatter interactions, for example. The voltage can be readily increased by one order of magnitude rather easily to 1 MV but not much easier for higher orders. Application of a high dielectric material layer to the metal sphere such as calcium copper titanate can further increase the surface charge by 3-5 orders of magnitude depending on crystallinity and layer thickness. This leaves approximately 6 orders of magnitude missing in order to target matter-antimatter reactions as pointed out in FIG. 1. Looking more carefully at σ=εₒεᵣE, the electric field E is defined by Voltage per unit Length, which can be also interpreted as Voltage per unit contour length; so when the contour length decreases the electric field increases as per:

$$E = \frac{V}{L} \qquad equation ( 3 )$$

So that,

$$σ = C \frac{V}{L} \qquad equation ( 4 )$$

Where C is the linear capacitance of the dielectric layer, V is the applied voltage, and L is the boundary length or the equivalent circumference; dimensional analysis is shown in FIG. 5, which yields surface charge density (Coulombs/m²) for this expression. Therefore, employing micro/nanostructures combined with high-k dielectric layers and applied potentials enables the creation of a new class of materials with ultra-high surface charge capabilities.

Electric field enhancement due to the “sharpness” of the charged object is a well-known phenomenon as can be seen with corona discharges predominant on edges of charged surfaces, and in applications that produce dense electron beams that utilize “Field Emitter Arrays”.

To further illustrate the concept of surface charge amplification by means of surface structures we can examine a few electric field simulation scenarios in FIG. 2. What we see in FIG. 2a is a cross section view of electric field lines from two discs, one above and one below, immersed in air and charged at some electric potential. These simulations are for illustrative purposes, thus absolute values are not required or noted. Notice how the electric field lines concentrate at the corner edges of the disc. Electric field stress concentration is also experimentally apparent with corona discharge predominant on sharper contours for electrically charged objects. Naturally then a hole within a substrate would achieve the same effect, which can be seen in FIG. 2b. It can be seen in FIG. 2c/d that an array of smaller holes leads to localized dense electric field regions that pinch off from the larger geometry field lines.

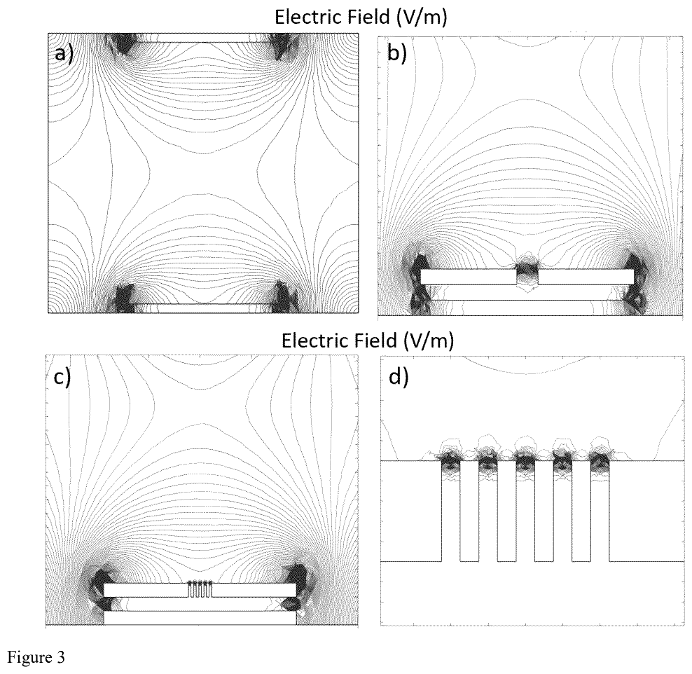

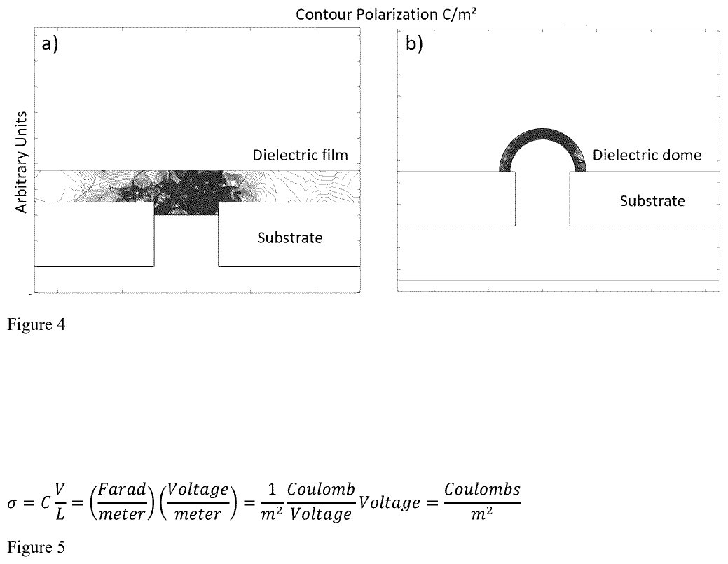

Recall equation 2, the product of the electric field and dielectric material linear capacitance yields surface charge density. The application of a dielectric film layer on top of the holes/sharp-edges of a thickness in proportion to the hole radius would therefore lead to high polarization of this film layer. The polarization P, known as the dipole moment per unit volume, carries the same units as surface charge (Coulomb/m²). The simulation software used here models polarization rather effectively as can be seen in FIG. 3.

The electric field emanating from the hole significantly polarizes the adjacent dielectric layer. Again, absolute units are not shown because it is only necessary to illustrate the concept at hand. It is noted that the polarization or surface charge exponentially diminishes as the thickness of the dielectric layer increases. If one changes the shape of the film to a dome like structure, the polarization is further enhanced by several orders of magnitude as simulation experiments show. Therefore, optimal shapes are possible through combinations of substrate micro/nanostructures, dielectric film structures, and dielectric materials, which maximize the surface charge density.

Example: An ultra-high surface charge accumulator is fabricated and tested as follows. A starting material such as aluminum, tungsten, bismuth, copper, or alloy is anodized in acidic or basic solutions at a temperature between 0-80° C. and a voltage between 40-180 V, which produces holes to a depth dependent on anodization time and hole diameters on the order of 10-200 nm. A ferroelectric material such as calcium copper titanate, barium titanate, or lead titanate is deposited as a film layer using sputtering, atomic layer deposition, or chemical vapor deposition to a thickness in one half proportion to the hole diameter. Post annealing of the deposited film is performed to increase the crystallinity and therefore the linear capacitance/dielectric constant is increased. An electrode is applied to the prepared film composite in a vacuum chamber at a pressure of 10⁻⁹ torr so that no electric breakdown or corona discharge occurs. The electrode is subjected to 10-500 kV from a calibrated power supply. Charge is accumulated on the ultra-high surface charge accumulator and the total current is calculated from the transient measured voltage across a resistor in series with the electrode, which enables a calculation of the actual charge accumulated. Accumulated charges are measured to be on the order of 1-10⁵ C/m² dependent on applied voltage, nanohole diameter, and dielectric constant.

1. A ultra-high surface charge accumulator, comprising:
a multilayer material composite arranged as an electrically conductive layer, nanostructured layer, and dielectric layer;
an electrically conductive substrate that can be directly or indirectly connected to a high voltage DC and/or AC power supply;
a nanostructured layer that is formed out of the substrate or applied to the substrate, which produces localized electric fields in the vicinity of the nanostructures;
a dielectric layer composed of ferroelectric material that accumulates surface charge from the underlying localized electric field produced by the nanostructures;
An AC and/or DC power supply that directly connects to or capacitively couples to the conductive layer.

2. The apparatus of claim 1, wherein the conductive substrate layer is aluminum or tungsten.

3. The apparatus of claim 2, wherein the nanostructured layer is alumina or tungsten oxide hexagonally arranged nanopores fabricated using anodization processes.

4. The apparatus of claim 1, wherein the nanostructured layer is gold, silver, or copper nanorods.

5. The apparatus of claim 1, wherein the dielectric layer is a ferroelectric material such as calcium copper titanate, barium titanate, or lead zirconium titanate.

6. The apparatus of claim 1, wherein the dielectric layer is shaped as a dome.

7. The apparatus of claim 5, wherein the thickness of the dielectric layer is in proportion to the radius of the nanostructures.
